(19) United States
(12) Patent Application Publication
(10) Pub. No.: US 2021/0366222 A1
(43) Pub. Date: Nov. 25, 2021

(54) Automated Processing the Output of Count Sort Machines

(71) Applicant: JCM American Corporation, Las Vegas, NV (US)

(72) Inventors: Paul Pechinko, Las Vegas, NV (US); Chris Blevens, Las Vegas, NV (US); David Kubajak, Las Vegas, NV (US)

(21) Appl. No.: 17/027,950

(22) Filed: Sep. 22, 2020

Related U.S. Application Data
(60) Provisional application No. 63/033,050, filed on Jun. 1, 2020.
(60) Provisional application No. 63/028,697, filed on May 22, 2020.

(51) Int. Cl. G07D 11/50; G07D 11/23; G07D 11/25; G07D 11/34; G07D 7/12; G07D 11/12

(52) U.S. Cl. CPC G07D 11/50; G07D 11/23; G07D 11/25; B25J 9/1679; G07D 7/12; G07D 11/12; G07D 11/34

(57) ABSTRACT

A system for processing output of at least one count sort machine evaluates data regarding cash box documents that are provided to at least one count sort machine. The system may determine one or more combinations of the cash box documents for one or more output containers using the data. The system may operate one or more movement mechanisms to move at least a portion of the cash box documents from one or more output ports of the at least one count sort machines to the one or more output containers based on the combination.

### CROSS-REFERENCE TO RELATED APPLICATION

This application is a nonprovisional of and claims the benefit under 35 U.S.C. § 119(e) of U.S. Provisional Patent Application No. 63/028,697, filed May 22, 2020, and U.S. Provisional Patent Application No. 63/033,050, filed Jun. 1, 2020, the contents of which are incorporated herein by reference as if fully disclosed herein.

### FIELD

The described embodiments relate generally to automated casino systems. More particularly, the present embodiments relate to automated systems for processing the output of count sort machines.

### BACKGROUND

Casinos are typically required, such as by one or more regulatory bodies, to maintain accurate records of all transactions involving one or more electronic gaming machines controlled by the casinos. For example, such transactions may include ticket in/ticket out transactions, player card transactions, currency of one or more types or denominations and/or other document deposits, and so on. In many cases, these records may be maintained and communicated from an electronic gaming machine to a local and/or remote server approved by the appropriate regulatory body or bodies.

Physical documents received by electronic gaming machines and/or one or more components associated therewith (such as one or more bill validators) may be stored in a “cash box,” which may be locked. Cash boxes may be retrieved from locations associated with the electronic gaming machines and transported to a location in the casino that may be secured, typically referred to as a “counting room.” A counting room may be tightly packed, leaving little available open space, and may become crowded with casino and/or counting room employees, cash boxes, carts and/or other equipment used to transport cash boxes, count sort machines and/or other accounting and/or counting room equipment, and so on.

Once in the counting room, cash boxes may typically be unlocked and/or otherwise opened in order to remove a stack or other configured set of documents (such as one or more tickets, currency, and so on) stored therein. This may be performed by one or more casino and/or counting room employees. The set of documents may be counted and sorted and/or otherwise aggregated, such as by providing the set of documents to a count sort machine, to verify that all currency and/or other transactions reported by the electronic gaming machines and/or associated components precisely match records. Thereafter, the emptied cash boxes may be locked and/or otherwise closed and replaced for use with one or more electronic gaming machines.

### SUMMARY

The present disclosure relates to processing the output of at least one count sort machine. Data regarding cash box documents provided to at least one count sort machine is evaluated in determining one or more combinations of the cash box documents for one or more output containers. One or more movement mechanisms are operated to move at least a portion of the cash box documents from one or more output ports of the at least one count sort machines to the one or more output containers based on the combination.

In various embodiments, a system for processing output of at least one count sort machine includes at least one movement mechanism at least one data source and at least one controller. The at least one controller receives data from the at least one data source regarding cash box documents provided to the at least one count sort machine, determines a combination of the cash box documents for an output container using the data, and operates the at least one movement mechanism to move at least a portion of the cash box documents from the at least one count sort machine to the output container based on the combination.

In some examples, the at least one movement mechanism includes a conveyor. In various examples, the at least one movement mechanism includes a linear robot. In some examples, the at least one controller moves the portion of the cash box documents after the portion of the cash box documents is banded.

In a number of examples, the combination includes a first number of a first currency denomination and a second number of a second currency denomination. In some examples, the combination is associated with an aggregate currency value.

In various examples, the at least one controller communicates the combination to at least one machine readable storage medium associated with the output container.

In some embodiments, a system for processing output of at least one count sort machine includes at least one movement mechanism, at least one sensor, and at least one controller. The at least one controller uses data regarding cash box documents provided to the at least one count sort machine to determine a combination of the cash box documents for an output container using the data, uses the at least one sensor to identify at least a portion of the cash box documents output by the at least one count sort machine, and operates the at least one movement mechanism to move the portion of the cash box documents from the at least one count sort machine to the output container in fulfillment of the combination.

In various examples, the at least one sensor is a camera. In some implementations of such examples, the at least one controller identifies the portion of the cash box documents using optical character recognition performed on at least one image of the portion of the cash box documents obtained via the camera.

In some examples, the at least one controller identifies the portion of the cash box documents by identifying at least one currency denomination associated with the portion of the cash box documents. In various examples, the at least one controller identifies the portion of the cash box documents by identifying at least one serial number associated with the portion of the cash box documents.

In a number of examples, the at least one controller identifies the portion of the cash box documents by identifying at least one security feature associated with the portion of the cash box documents. In some implementations of such examples, the at least one security feature includes at least one of an infrared strip or an ultraviolet strip.

In a number of embodiments, a system for processing output of at least one count sort machine includes at least one movement mechanism, at least one sensor, and at least one controller. The at least one controller uses the at least one sensor to identify at least a portion of cash box documents output by the at least one count sort machine and operates the at least one movement mechanism to move the portion of the cash box documents from the at least one count sort machine to an output container based on a combination determined using data regarding the cash box documents provided to the at least one count sort machine.

In various examples, the at least one controller uses at least one locking mechanism to lock the output container after the output container contains the combination. In some examples, the at least one controller identifies the portion of the cash box documents by determining which of a number of output ports of the at least one count sort machine output the portion of the cash box documents.

In a number of examples, the at least one controller identifies the portion of the cash box documents by using the at least one sensor to obtain identification data from at least one machine readable element associated with at least one band wrapping at least a part of the portion of the cash box documents. In some implementations of such examples, the at least one machine readable element includes at least one barcode.

In various examples, the combination is associated with an aggregate currency denomination number.

### BRIEF DESCRIPTION OF THE DRAWINGS

The disclosure will be readily understood by the following detailed description in conjunction with the accompanying drawings, wherein like reference numerals designate like structural elements.

FIG. 1A depicts an example system for processing output of at least one count sort machine.

FIG. 1B depicts the system of FIG. 1A after the count sort machine outputs a set of sorted and counted documents via an output port.

FIG. 1C depicts the system of FIG. 1B after the system moves the set of counted and sorted documents to the output container.

FIG. 1D depicts the system of FIG. 1C after the system closes and locks the output container.

FIG. 1E depicts an example implementation of the output container of the system of FIGS. 1A-1D.

FIG. 2 depicts a casino system into which the system processing the output of at least one count sort machine of FIGS. 1A-1E may be incorporated.

FIG. 3 depicts an alternative implementation of the system of FIG. 1A.

FIG. 4 depicts a flow chart illustrating a first example method for processing the output of at least one count sort machine. This method may be performed by one or more of the systems of FIG. 1A-3.

FIG. 5 depicts a flow chart illustrating a second example method for processing the output of at least one count sort machine. This method may be performed by one or more of the systems of FIG. 1A-3.

FIG. 6 depicts a flow chart illustrating a first example method for facilitating reconciliation between reported transactions and physical tickets stored in a cash box to account for variances that may result from virtual ticket and/or other operations. This method may be performed by the casino system of FIG. 2 and/or one or more of the other systems discussed and/or referenced herein.

FIG. 7 depicts a flow chart illustrating a second example method for facilitating reconciliation between reported transactions and physical tickets stored in a cash box to account for variances that may result from virtual ticket and/or other operations. This method may be performed by the casino system of FIG. 2 and/or one or more of the other systems discussed and/or referenced herein.

FIG. 8 depicts a flow chart illustrating a third example method for facilitating reconciliation between reported transactions and physical tickets stored in a cash box to account for variances that may result from virtual ticket and/or other operations. This method may be performed by the casino system of FIG. 2 and/or one or more of the other systems discussed and/or referenced herein.

FIG. 9 depicts a flow chart illustrating a fourth example method for facilitating reconciliation between reported transactions and physical tickets stored in a cash box to account for variances that may result from virtual ticket and/or other operations. This method may be performed by the casino system of FIG. 2 and/or one or more of the other systems discussed and/or referenced herein.

FIG. 10 depicts a flow chart illustrating a first example method for processing information related to contents of cash boxes in a casino environment. This method may be performed by the casino system of FIG. 2 and/or one or more of the other systems discussed and/or referenced herein.

FIG. 11 depicts a flow chart illustrating an example method for reconciliation of reported transactions and physical tickets stored in a cash box to account for variances that may result from virtual ticket and/or other operations. This method may be performed by the casino system of FIG. 2 and/or one or more of the other systems discussed and/or referenced herein.

FIG. 12 depicts a flow chart illustrating a second example method for processing information related to contents of cash boxes in a casino environment. This method may be performed by the casino system of FIG. 2 and/or one or more of the other systems discussed and/or referenced herein.

FIG. 13 depicts a flow chart illustrating an example method for configuring cash boxes for use with gaming machines. This method may be performed by the casino system of FIG. 2 and/or one or more of the other systems discussed and/or referenced herein.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Documents (such as one or more tickets, currency, header and/or trailer cards describing transactions involved with the documents and/or one or more electronic gaming machines and/or other components that were involved with the transaction, and so on) from one or more cash boxes in a casino environment may be provided to one or more count sort machines in one or more counting rooms in order to count and/or sort and/or otherwise aggregate the documents. Count sort machines may include at least one input port where unsorted set or sets of documents are provided. A count sort machine may then sort the provided set or sets of documents (such as sorting a set of United States currency into groups of $1 bills, $5 bills, $10 bills, $20 bills, $50 bills, $100 bills, and so on), count the sorted set or sets of documents, count the sorted set or sets of documents, reconcile the count with records of one or more accounting servers and/or other servers, and/or output the counted sorted set or sets of documents. For example, a count sort machine may include separate output ports (and/or pairs and/or other combinations thereof) for different sorted groups (such as a pair of output ports for each of United States $1 bills, $5 bills, $10 bills, $20 bills, $50 bills, $100 bills, and so on). Output from respective output ports may be collected into groups by bundling and/or banding or other securing mechanisms, such as by placing bands around each group of 100 bills of a respective denomination (and/or banding groups of banded bills). These banded bills may be placed into bags and/or other output containers for routing as a deposit to a bank, transportation to a teller cage or other location in a casino for use, and so on.

However, the process of regularly collecting cash boxes, transporting cash boxes to a counting room, opening and/or otherwise unlocking cash boxes, removing sets of documents from cash boxes, providing sets of documents to one or more count sort machines, collecting counted and sorted (and/or banded and/or otherwise bundled) sets of documents output by one or more count sort machines, placing counted and sorted and/or otherwise aggregated (and/or banded and/or otherwise bundled) sets of documents in bags and/or other output containers, closing and/or otherwise relocking cash boxes, and distributing empty cash boxes for use with electronic gaming machines may be time consuming, inefficient, and subject to human error. Counting rooms may also use a large area and involve many employees for processing cash boxes. This may consume casino space that might otherwise be used for other purposes, such as additional electronic gaming machines, guest services (e.g., shows, restaurants, shops, and the like). The cost associated with such employees operating a conventional counting room may be high.

Further, count sort machines are most efficient when the input port, various output ports, and the various counting and sorting mechanisms operating therebetween are in constant operation. Halts in operation (such as related to waiting for a counting room employee to remove counted and sorted and/or banded and/or otherwise bundled sets of documents from an output port and determining the output bag or other container into which they should go, waiting for mechanisms to become available, and so on) may cause count sort machines to operate inefficiently, cause wear on count sort machines, cause count sort machine operation to be more expensive than it should be, and so on.

The following disclosure relates to processing the output of at least one count sort machine. Data regarding cash box documents provided to at least one count sort machine is evaluated in determining one or more combinations of the cash box documents for one or more output containers. One or more movement mechanisms are operated to move at least a portion of the cash box documents from one or more output ports of the at least one count sort machines to the one or more output containers based on the combination.

In this way, the at least one count sort machine is operated more efficiently without halts in operation to have employees determine the combinations, collect counted and sorted and/or banded and/or otherwise bundled sets of documents from one or more output ports, move counted and sorted and/or banded and/or otherwise bundled sets of documents to one or more output containers, and so on. This may result in a system that operates more efficiently while using less components and/or resources.

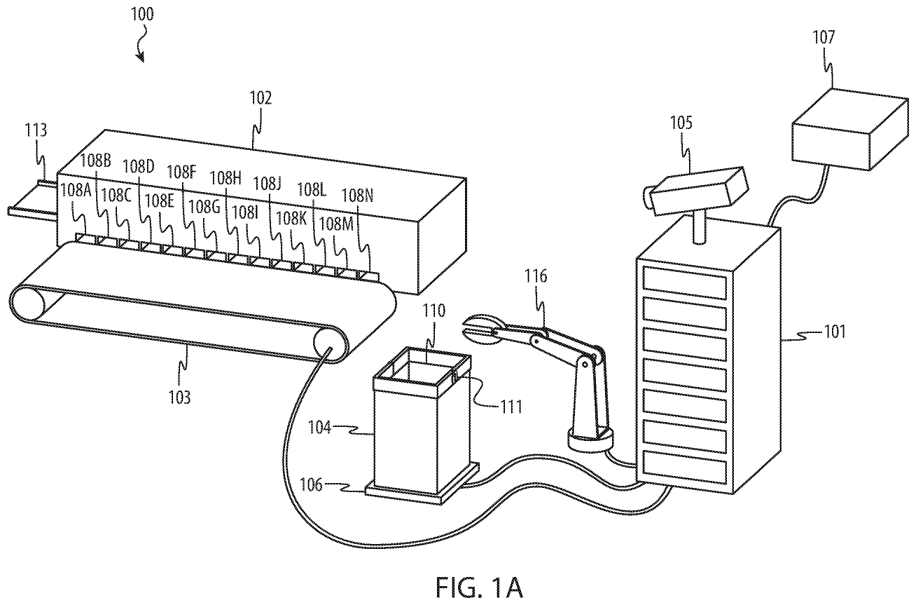

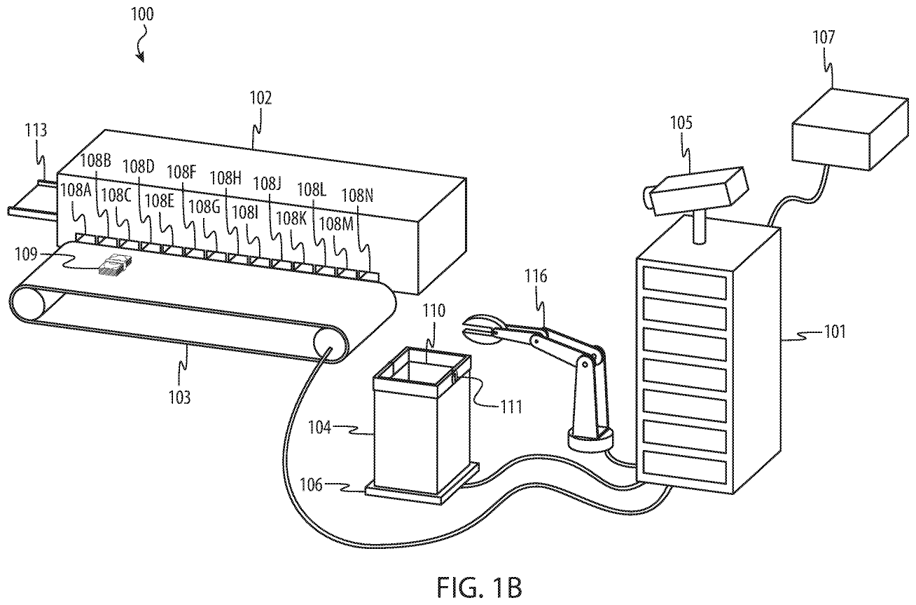

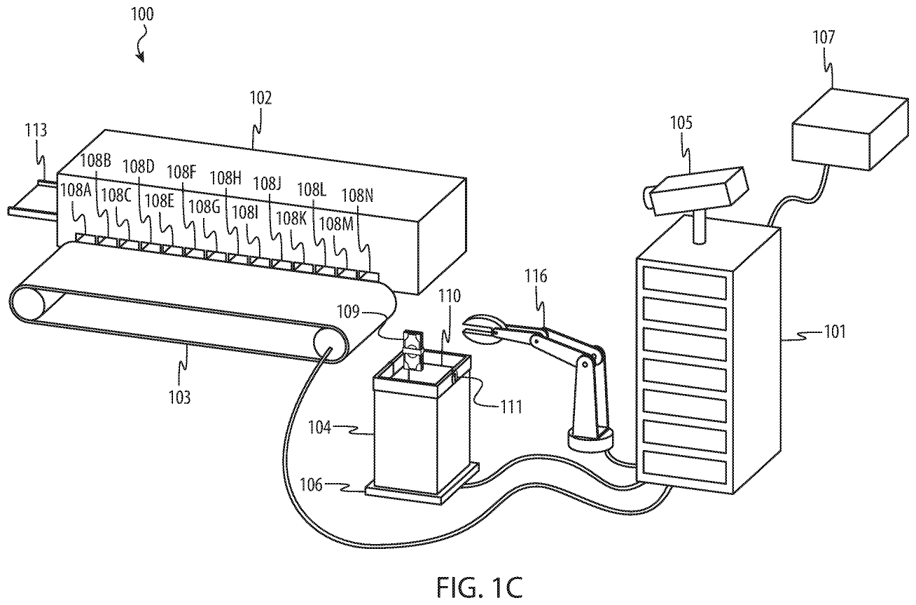

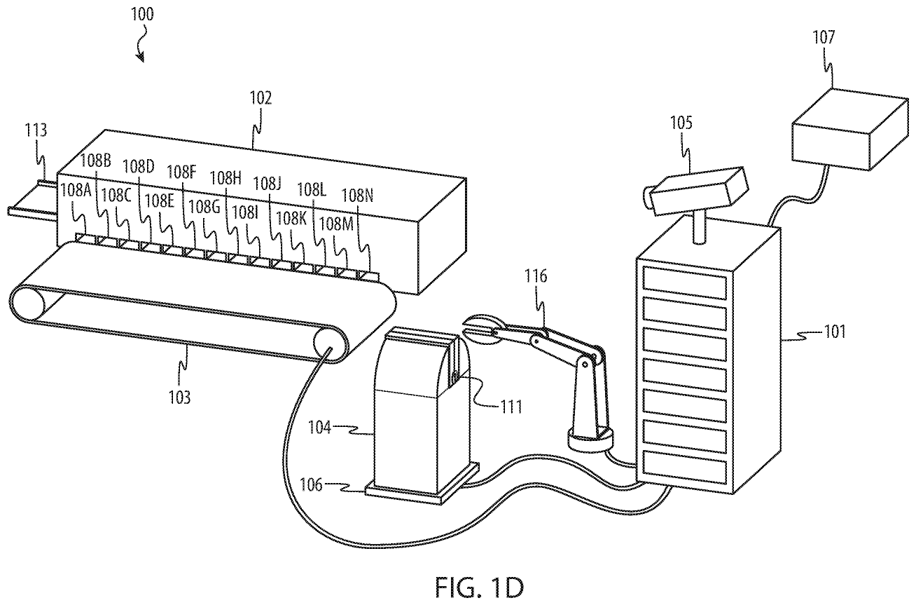

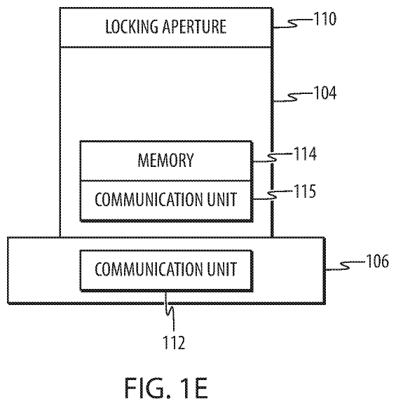

These and other embodiments are discussed below with reference to FIGS. 1-5. However, those skilled in the art will readily appreciate that the detailed description given herein with respect to these Figures is for explanatory purposes only and should not be construed as limiting.

FIG. 1A depicts an example system 100 for processing the output of at least one count sort machine. The system 100 may include one or more controllers 101, movement mechanisms 103 (such as one or more conveyor systems, linear robots, mechanical arms, and so on), sensors 105 (such as one or more cameras and/or other image sensors, bar code readers, radio frequency identifier and/or other antennas), locking and/or output container manipulation mechanisms 116 (such as one or more linear robots, mechanical arms, keys, and so on), output container interface mechanisms 106, and so on.

The controller 101 may process the output of at least one count sort machine 102. The controller 101 may evaluate data regarding cash box documents provided to the count sort machine 102. The controller 101 may receive and/or otherwise obtain this data from one or more data sources 107. The controller 101 may use the data to determine one or more combinations of the cash box documents for one or more output containers 104. The controller 101 may use the sensor 105 to detect a portion of the cash box documents at one or more output ports 108A-108N of the count sort machine 102. The controller 101 may operate the movement mechanism 103 to move at least a portion of the cash box documents from one or more output ports 108A-108N of the count sort machine 102 to the output container 104 based on the combination.

In this way, the count sort machine 102 is operated more efficiently without halts in operation to have employees determine the combinations, collect the cash box documents from the output ports 108A-108N of the count sort machine 102, move the cash box documents to the output containers 104, and so on. As a result, the system 100 may operate more efficiently than previous systems while using less components and/or resources.

The data source 107 may be and/or obtain the data from a variety of sources. For example, cash boxes may be intelligent cash boxes that include one or more components (such as one or more processing units or other processors or controllers, memories or other storage media, communications units, and so on) that receive, store, and/or provide information regarding documents received by the cash box and/or transactions involved therewith. For example, this information may include serial numbers and/or other identifiers associated with related electronic gaming machines or other components, values associated with received documents (such as $10 associated with a United States $10 bill), numbers of different kind of documents received (such as 100 received United States $20 bills), total value associated with received documents (such as $10,000 received of United States currency), serial numbers and/or other identifiers associated with received documents (such as currency serial numbers, ticket identifiers, and so on), images of received documents, and so on. The controller 101 may obtain such data from the intelligent cash boxes and/or one or more intermediaries (such as an accounting server, a casino server, an additional services server and/or other server, a cart communicably coupled to the cash boxes, a bill validator or other component communicably coupled to the cash box, and so on). Alternatively and/or additionally, the controller 101 may obtain such data from another component without involvement of the cash box, such as a bill validator that receives documents before providing the documents to the cash box. Various configurations are possible and contemplated without departing from the scope of the present disclosure.

Documents (such as one or more tickets, currency, header and/or trailer cards describing transactions involved with the documents and/or one or more electronic gaming machines and/or other components that were involved with the transaction, and so on) from one or more cash boxes in a casino environment may be provided to one or more input ports 113 (such as a document feeder, hopper, or similar component) of the count sort machine 102. The count sort machine 102 may then sort and/or otherwise aggregate the provided set or sets of documents (such as sorting a set of United States currency into groups of $1 bills, $5 bills, $10 bills, $20 bills, $50 bills, $100 bills, and so on), count the sorted set or sets of documents, reconcile the count with records of one or more accounting servers and/or other servers, and/or output the counted sorted set or sets of documents via one or more output ports 108A-108N (such as a document feeder, hopper, or similar component). The count sort machine 102 may include separate output ports 108A-108N (and/or pairs and/or other combinations thereof, which may allow the count sort machine 102 to continue operation when out of the pair and/or other combination thereof is busy) for different sorted groups (such as a pair of output ports for each of United States $1 bills, $5 bills, $10 bills, $20 bills, $50 bills, $100 bills, and so on). Output from respective output ports 108A-108N may be banded into groups by bundling and/or banding mechanisms, such as by placing bands around each group of 100 bills of a respective denomination (and/or banding groups of banded bills).

The controller 101 may then use the sensor 105 and/or the movement mechanism 103 to detect the documents output by the count sort machine 102 (such as the banded bills, move the outputted documents based on the determined combination to the output container 104, and so on. Once the controller 101 determines that the combination is complete, the controller 101 may then route and/or signal routing of the output container 104 as a deposit to a bank, transportation to a teller cage or other location in a casino for use, and so on.

For example, the controller 101 may evaluate the data to determine that one or more sets of documents are going to be provided to the count sort machine 102 including 1000 United States $100 bills, 100 United States $50 bills, 300 United States $20 bills, 500 United States $10 bills, 250 United States $5 bills, and 100 United States $1 bills. The controller 101 may determine a combination of $110,000 to route for a deposit and a combination of $7350 to route to supply a teller cage. As such, the controller 101 may use the sensor 105 and the movement mechanism 103 to detect and direct outputs of the count sort machine 102 based on the determined combinations to move the 1000 United States $100 bills, the 100 United States $50 bills, and the 500 United States $10 bills to a first output container 104 for the deposit and the 300 United States $20 bills, the 250 United States $5 bills, and the 100 United States $1 bills to a second output container 104 for the teller cage. However, it is understood that this is an example. In various implementations, determined combinations may take other factors into account, such as numbers of documents that are banded together (such as 100) as this may affect associated value amounts that may be moved as outputs from the count sort machine 102. As another example, a specific group of denominations comprising a set amount of currency could be generated as an output for supplying cash tills or ATM or kiosk float.

Although the above discusses counting and sorting currency, other documents may be counted, sorted, and/or otherwise aggregated. For example, such documents may include tickets. The count sort machine 102 may output tickets separated from other documents and these output tickets may be banded, provided to a respective output container 104, stored, destroyed, a combination thereof, and/or otherwise processed. Various configurations are possible and contemplated without departing from the scope of the present disclosure.

In various implementations, the sensor 105 may be one or more of a variety of different sensors. Such sensors may include, but are not limited to, one or more cameras and/or other image sensors, bar code readers, radio frequency identifier and/or other antennas. For example, a camera may capture one or more images of a banded stack of documents output by the count sort machine 102, perform optical character recognition on the image to determine an associated currency denomination (such as by recognizing a denomination number on a document, a serial number associated with a denomination on a documents, and so on), and detect the output accordingly. In another example, the camera may take one or more ultraviolet and/or infrared images. Documents, such as United States currency, may include ultraviolet strip, infrared strip, and/or other markers or security features that are specific to a certain denomination. Such markers or security features may be analyzed via the image and used to detect the output accordingly. In still another example, one or more bands used to wrap the documents may include a machine readable element (such as a quick read barcode, a matrix barcode, a 2D barcode, a radio frequency identification tag, a near-field communication element, and so on) and the sensor 105 may include a reader for reading the machine readable element, which may communicate information about the presence of the document, a currency denomination or value, and so on. In yet another example, the controller 101 may use a camera, proximity sensor, or other sensor 105 to determine which output ports 108A-108N output documents. Each of the output ports 108A-108N may be associated with a particular type of document and the controller 101 may identify output documents based on the output ports 108A-108N that output the respective document. Various configurations are possible and contemplated without departing from the scope of the present disclosure.

FIG. 1B depicts the system 100 of FIG. 1A after the count sort machine 102 outputs a set of sorted and counted documents 109 via an output port 108C. The controller 101 may use the sensor 105 to detect the output and use the movement mechanism 103 to move the set of sorted and counted documents 109 to the output container 104, as shown in FIG. 1C.

In some implementations, the output container 104 may include a lockable aperture 110 that is operable to be manipulated between an open and a closed position and/or locked via a lock 111. In such implementations, the controller 101 may use the output container manipulation mechanism 116 to unlock the lock 111, open the lockable aperture 110, close the lockable aperture 110, lock the lock 111 (such as by inserting one or more keys into one or more keyways, rotating such keys, and so on), and so on. FIG. 1D depicts the system 100 of FIG. 1C after the system 100 closes and locks the output container 104 using the output container manipulation mechanism 116.

As discussed above, in some implementations, the system 100 may include one or more output container interface mechanisms 106. For example, the output container 104 may be an intelligent container that includes one or more components (such as one or more processing units or other processors or controllers, memories or other storage media, communications units, and so on) that receive, store, and/or provide information regarding documents stored by the output container 104. This information may be communicated to the output container 104 via the output container interface mechanism 106 before the documents are put into the output container 104, as the documents are put into the output container 104, after the documents are put into the output container 104, after the output container 104 is locked, and/or in any other way of combination thereof. In this way, the output container 104 itself may be configured to store and/or provide a verifiable record as to the contents of the output container 104 and/or various information about such. For example, in many situations, a bag transported from a counting room in a casino to a teller cage will be counted upon arrival to ensure no errors or theft occurred. However, in the situation of this implementation of the system 100, the locked output container 104 may be queried for the verifiable record and the teller cage may be able to rely that no errors or theft occurred without counting. Similarly, a bank receiving the locked output container 104 may query the locked output container for the verifiable record and may provide an account corresponding to the casino a provisional credit for the contained amount previous to and/or instead of recounting the documents.

Accordingly, FIG. 1E depicts an example implementation of the output container 104 of the system 100 of FIGS. 1A-1D. As shown, the output container 104 may include the lockable aperture 110, a memory 114, and a communication unit 115. Also as shown, the output container interface mechanism 106 may also include a communication unit 112. The communication unit 112 may be used to communicate with the communication unit 115 to store information in and/or query information from the memory 114. The communication units 112 and 115 may be communicably coupled and/or communicate using a variety of different wired and/or wireless communication mechanisms. For example, the communication units 112 and 115 may communicate using WiFi, near-field communication, Bluetooth communication, a serial connection, a universal serial bus connection, a capacitive connection, and so on. Various configurations are possible and contemplated without departing from the scope of the present disclosure.

The controller 101 may be any kind of electronic device. Examples include, but are not limited to, one or more desktop computing devices, laptop computing devices, mobile computing devices, wearable devices, smart phones, tablet computing devices, and so on. The controller 101 may include one or more processors and/or other processing units and/or control units, one or more communication units, one or more non-transitory storage media (which may take the form of, but is not limited to, a magnetic storage medium; optical storage medium; magneto-optical storage medium; read only memory; random access memory; erasable programmable memory; flash memory; and so on), and/or one or more other components. The processor may execute one or more instructions stored in the storage medium to perform various functions. Such functions may include, but are not limited to, processing the output of at least one count sort machine 102, receiving and/or otherwise obtaining and/or processing data regarding cash box documents provided to the count sort machine 102, communicating with the data source 107, determining one or more combinations of the cash box documents for one or more output containers 104, using the sensor 105 to detect a portion of the cash box documents at one or more output ports 108A-108N of the count sort machine 102, operating the movement mechanism 103 to move at least a portion of the cash box documents from one or more output ports 108A-108N of the count sort machine 102 to the output container 104 based on the combination, and so on.

Although the system 100 is illustrated and described above as including particular components configured in a particular arrangement, it is understood that this is an example and other configurations of the same, similar, and/or different components may be used. For example, in some implementations, the controller 101 may be operable to move one or more documents into multiple different output containers 104 at the same and/or substantially similar times without departing from the scope of the present disclosure.

The movement mechanism 103 is illustrated as a conveyor system involving a single conveyor. However, it is understood that this is an example. In other implementations, the movement mechanism 103 may be one or more conveyors and/or conveyor systems, mechanical arms, linear and/or other robots, pistons, grabbers, and/or any other mechanism operable to move one or more documents in a variety of directions. For example, there may be multiple output containers 104, each served by one or more of the conveyor system components. Various configurations are possible and contemplated without departing from the scope of the present disclosure.

The output container 104 is illustrated as a lockable bag. However, is understood that this is an example. In other implementations, the output container 104 may include any kind of bag, box, and/or other lockable, non-lockable, closeable, non-closeable, and/or other container without departing from the scope of the present disclosure.

The output container 104 is also depicted as configured to allow documents to fall from the movement mechanism 103 into the output container 104 through the open aperture 110. However, is understood that this is an example. In other implementations, the output container 104 may be coupled to the movement mechanism 103 such that access to documents positioned between the output ports 108A-108N and the output container 104 is prevented. In such an implementation, the output container 104 may unlock and/or open when coupled to the movement mechanism 103 and/or may close and/or lock prior to and/or at removal from the movement mechanism 103. Various configurations are possible and contemplated without departing from the scope of the present disclosure.

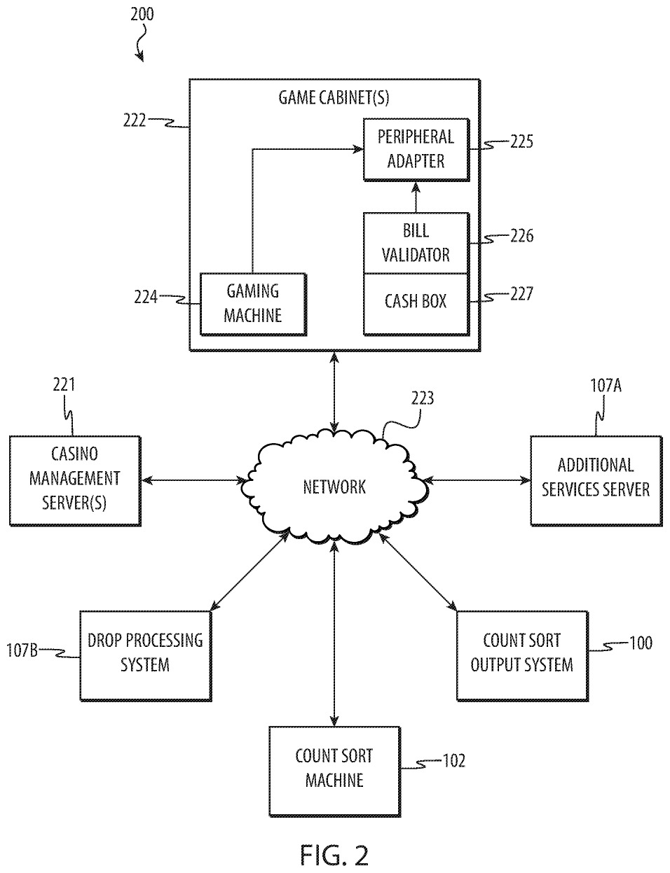

FIG. 2 depicts a casino system 200 into which the system 100 processing the output of at least one count sort machine 102 of FIGS. 1A-1E may be incorporated. As shown, the casino system 200 may include one or more electronic game cabinets 222. The game machine cabinets 222 may each include one or more electronic gaming machines 224, peripheral adapters 225, bill validators 226 and/or other components (such as ticket printers, displays, and so on), and/or cash boxes 227.

The components of the casino system 200 may include any of the devices and/or perform any of the techniques discussed in U.S. application Ser. No. 14/494,629 (titled “Electronic Voucher System”, filed Sep. 24, 2014), U.S. application Ser. No. 15/482,615 (titled “Bill Validation and Cash Dispensing Device, System and Method for Use in a Casino Context”, filed Apr. 7, 2017), U.S. application Ser. No. 16/216,839 (titled “Banknote Handling System for Automated Casino Accounting”, filed Dec. 11, 2018), U.S. application Ser. No. 16/810,307 (titled “Drop Cart with Cashbox Data Reader Array and Autonomous Drop Cart Processing System for Automated Casino Accounting”, filed Mar. 5, 2020), U.S. application Ser. No. 16/855,089 (titled “Currency Tracking and Accounting Systems”, filed Apr. 22, 2020), and U.S. application Ser. No. 16/719,249 (titled “Automatic Bill Handling System”, filed Dec. 18, 2019), the contents of all of which are incorporated by reference as if fully disclosed herein.

The peripheral adapter 225 and/or the gaming machine 224, the bill validator 226, and/or the cash box 227 (via the peripheral adapter 225 in some cases) may communicate via one or more networks 223. By way of illustration, the peripheral adapter 225 and/or the gaming machine 224, the bill validator 226, and/or the cash box 227 (via the peripheral adapter 225 in some cases) may communicate with one or more casino management servers 221 (which may include one or more ticketing servers, player account servers, ticket account servers, accounting servers, slot account servers, and so on) and/or additional services servers 107A (which may include one or more ticketing servers, player account servers, ticket account servers, accounting servers, slot account servers, and so on) via the network 223.

For example, the bill validator 226 may communicate with the cash box 227 and the additional services server 107A regarding information for documents received by the bill validator 226 and/or stored by the cash box 227. This information may include serial numbers and/or other identifiers associated with related electronic gaming machines or other components, values associated with received documents (such as $10 associated with a United States $10 bill), numbers of different kind of documents received (such as 100 received United States $20 bills), total value associated with received documents (such as $10,000 received of United States currency), serial numbers and/or other identifiers associated with received documents (such as currency serial numbers, ticket identifiers, and so on), images of received documents, and so on. The cash box 227 and/or the additional services server 107A may store such information and/or communicate with one or more other devices regarding such information.

By way of illustration, the additional services server 107A may communicate with the count sort machine 102 regarding this information as part of reconciling the information and/or one or more accounts or records with counting and/or sorting of documents performed by the count sort machine 102. Bill validators 226 may also track, store, and communicate information regarding detection of counterfeit documents, whether or not to accept and/or reject documents, failures, cash box 227 capacity, and so on. This information may be used, such as by the additional services server 107A to signal maintenance, cash box 227 collection, and/or other actions.

By way of another example, the additional services server 107A may communicate with the gaming machine 224, the peripheral adapter 225, and/or the bill validator 226 regarding one or more ticket-in, ticket-out transactions. By way of illustration, the additional services server 107A may instruct one or more of the gaming machine 224, the peripheral adapter 225, and/or the bill validator 226 that a ticket is received based on a ticket and/or other account (such as from an electronic account that stores information about virtual tickets, an electronic account that is associated with a payment account that may be converted to virtual tickets, and so on). This virtual ticket may result in the gaming machine 224, the peripheral adapter 225, and/or the bill validator 226 behaving as if a physical ticket has been received, though the corresponding physical ticket may not be stored in the cash box 227. The additional services server 107A may also communicate with the gaming machine 224, the peripheral adapter 225, and/or the bill validator 226 in order to credit such accounts using such virtual tickets rather than a printer or other value output device associated with the gaming machine 224 printing physical tickets and/or providing other value outputs. The additional services server 107A may provide information (such as to the count sort machine 102, the count sort output system 100, and so on) regarding virtual ticket operations to enable, facilitate, and/or otherwise reconcile transaction records with contents of the cash box 227. For example, the gaming machine 224, the peripheral adapter 225, and/or the bill validator 226 may report all transactions to a slot accounting server, other accounting server, and/or other casino management server 221. Virtual ticket operations may result in the gaming machine 224, the peripheral adapter 225, and/or the bill validator 226 reporting transactions to the slot accounting server, other accounting server, and/or other casino management server 221 that correspond to received tickets. However, since the tickets are virtual, they may not be in the cash box 227 as the count sort machine 102 expects based on information received from the slot accounting server, other accounting server, and/or other casino management server 221. As such, the count sort machine 102 and/or other components may use the information regarding virtual ticket operations received from the additional services server 107A to reconcile discrepancies between transactions reported by the gaming machine 224, the peripheral adapter 225, and/or the bill validator 226 with physical tickets present in the cash box 227. Various configurations are possible and contemplated without departing from the scope of the present disclosure.

A drop system 107B may be used to process cash boxes 227 in preparation for counting and sorting of documents from the cash boxes 227 by the count sort machine 102. For example, one or more cash boxes 227 may be removed from one or more game cabinets 222 and loaded onto one or more drop carts. The drop carts may be configured to communicably connect to the cash boxes 227 to obtain information stored thereon and/or communicate such information to one or more other devices, such as the casino management server 221, the additional services server 107A, the system 100 (and/or a controller thereof), and so on. The drop system 107B may include various movement mechanisms (such as one or more conveyor systems, linear robots, mechanical arms, and so on) for opening one or more drop carts, unlocking and/or opening one or more cash boxes 227, removing one or more cash boxes 227 from a drop cart, loading one or more cash boxes 227 on a drop cart, removing one or more sets of documents from one or more cash boxes 227, providing one or more sets of documents from one or more cash boxes 227 to one or more count sort machines 102, communicating data (such as to the casino management server 221, the additional services server 107A, the system 100 and/or a controller thereof, and so on) regarding one or more sets of documents removed from one or more cash boxes 227 and/or provided to one or more count sort machines 102. Such data may include any of the information stored by the cash boxes 227, the bill validator 226, the additional services server 107A, and so on.

The count sort machine 102 may receive one or more sets of documents removed from one or more cash boxes 227, sort and/or count one or more sets of documents removed from one or more cash boxes 227, communicate with the additional services server 107A and/or other devices to reconcile counted and sorted documents with one or more transaction records, output counted and/or sorted documents, and so on. The output counted and/or sorted documents may be banded and/or otherwise processed. The system 100 may process such output, as described above.

The casino system 200 may use the various components and/or information communicated in between such components to perform various functions. Such functions may include automatic reconciliation, fault tracking, fault analysis, anti-theft, anti-counterfeiting measures, casino system 200 flow adjustment and flow efficiency adjustment, and so on.

Although the casino system 200 is illustrated and described above as including particular components configured in a particular arrangement, it is understood that this is an example and other configurations of the same, similar, and/or different components may be used. For example, in some implementations, the additional services server 107A may operate as the controller of the system 100 without departing from the scope of the present disclosure.

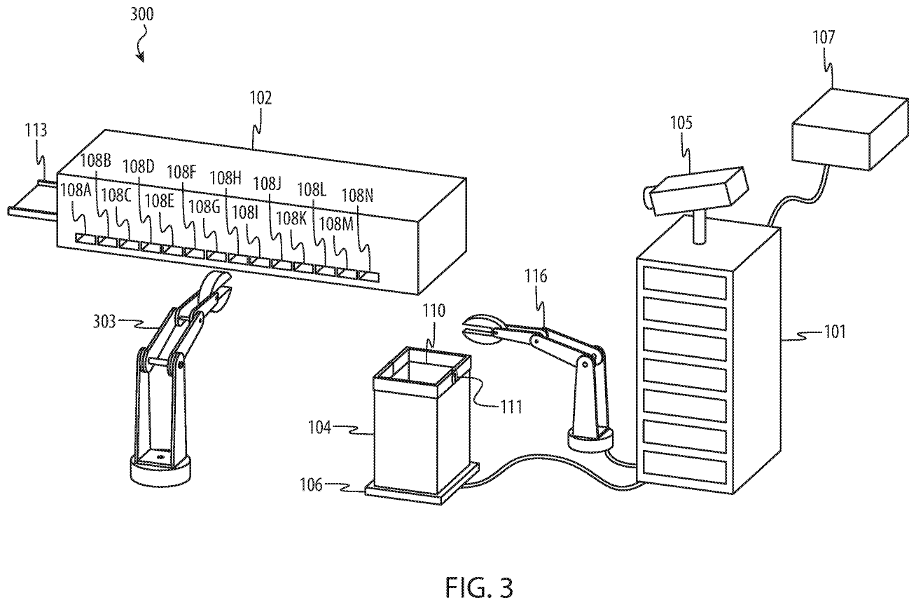

FIG. 3 depicts an alternative implementation 300 of the system 100 of FIG. 1A. As contrasted with the system 100 of FIG. 1A, a linear robot and/or other mechanical arm 303 may be used instead of a conveyor system. Sets of documents may be provided to the input port 113 of at least one count sort machine 102 and counted and sorted documents may be output via one or more of the output ports 108A-108N. The controller 101 may use data from the data source 107 to determine one or more combinations. The controller 101 may then use the sensor 105 to detect outputted documents, control the mechanical arm 303 to grab and move the outputted documents into the aperture 110 of the output container 104 based on the combination, communicate data about the combination and/or the documents to the output container 104 via the output container interface mechanism 106, close and lock the lock 111 of the output container 104 via the output container manipulation mechanisms 116, and so on.

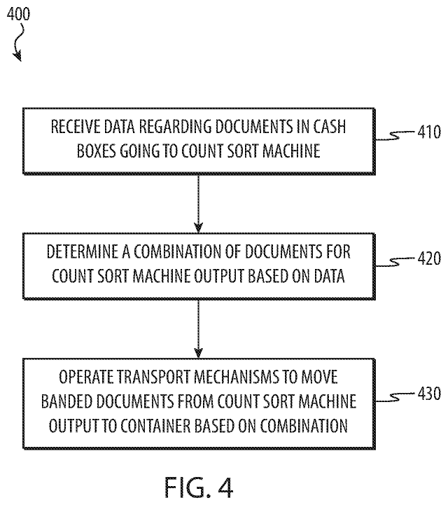

FIG. 4 depicts a flow chart illustrating a first example method 400 for processing the output of at least one count sort machine. This method 400 may be performed by one or more of the systems of FIG. 1A-3.

At operation 410, an electronic device (such as the controller 101 of FIG. 1) may receive data regarding documents in cash boxes going to and/or being provided to a count sort machine. The electronic device may receive such data from the cash boxes, from a drop cart or drop system communicably connected to the drop boxes, from one or more servers communicably connected to the cash boxes and/or one or more drop carts or drop systems, and so on.

At operation 420, the electronic device may determine a combination of documents for a count sort machine output based on the data. The electronic device may determine the combination based on an aggregate value, an aggregate number of documents, an aggregate number of a particular type of documents (such as currency denominations), deposit requirements, and/or other parameters or requirements.

At operation 430, the electronic device may operate one or more transport mechanisms to move banded documents from one or more outputs of the count sort machine to one or more containers based on the combination. Such transport mechanisms may include one or more conveyor systems, linear and/or other robots, mechanical arms, and so on.

In various examples, this example method 400 may be implemented as a group of interrelated software modules or components that perform various functions discussed herein. These software modules or components may be executed within a cloud network and/or by one or more electronic devices, such as the controller 101 of FIG. 1A.

Although the example method 400 is illustrated and described as including particular operations performed in a particular order, it is understood that this is an example. In various implementations, various orders of the same, similar, and/or different operations may be performed without departing from the scope of the present disclosure.

For example, operation 430 is illustrated and described as having the electronic device operate one or more transport mechanisms to move banded documents. However, in some implementations, the documents may not be banded. In still other implementations, banding may occur during transport and/or at the direction of the electronic device. Various configurations are possible and contemplated without departing from the scope of the present disclosure.

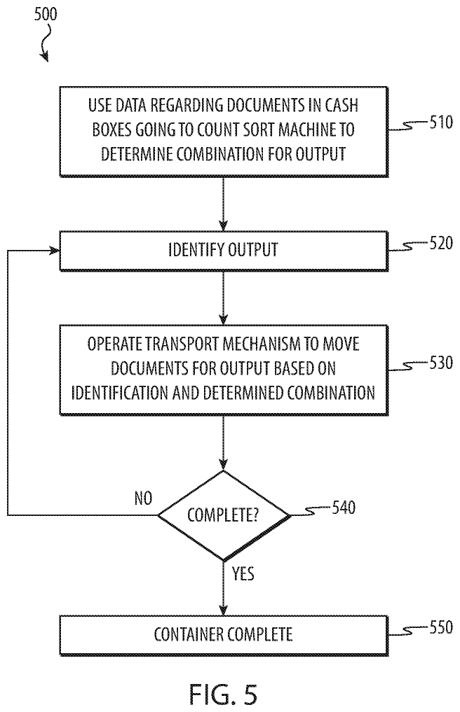

FIG. 5 depicts a flow chart illustrating a second example method 500 for processing the output of at least one count sort machine. This method 500 may be performed by one or more of the systems of FIG. 1A-3.

At operation 510, an electronic device (such as the controller 101 of FIG. 1) may use data regarding documents in cash boxes going to and/or being provided to a count sort machine to determine a combination of documents for a count sort machine output based on the data. The electronic device may obtain such data from the cash boxes, from a drop cart or drop system communicably connected to the drop boxes, from one or more servers communicably connected to the cash boxes and/or one or more drop carts or drop systems, and so on. The electronic device may determine the combination based on an aggregate value, an aggregate number of documents, an aggregate number of a particular type of documents (such as currency denominations), deposit requirements, and/or other parameters or requirements.

At operation 520, the electronic device may identify output of the count sort machine. For example, the electronic device may use one or more cameras or other sensors to detect that the count sort machine has output counted and/or sorted documents and identify what documents the count sort machine has output. By way of illustration, the electronic device may use the camera to obtain an image and process the image to determine that the count sort machine has output a banded stack of United States $100 bills.

At operation 530, the electronic device may operate one or more transport mechanisms to move documents from the output of the count sort machine to one or more containers based on the combination. Such transport mechanisms may include one or more conveyor systems, linear and/or other robots, mechanical arms, and so on.

At operation 540, the electronic device may determine if the combination is complete. For example, the combination may be complete if all documents included in the combination have been moved to the container. If the combination is complete, the flow may proceed to operation 550. Otherwise, the flow may return to operation 520 where the electronic device may again identify output of the count sort machine.

At operation 550, the electronic device completes the container. This may include directing one or more devices to close the container, lock the container, communicate data regarding contents of the container to a memory of the container, signal one or more movement mechanisms to begin routing the container to a destination, and so on.

In various examples, this example method 500 may be implemented as a group of interrelated software modules or components that perform various functions discussed herein. These software modules or components may be executed within a cloud network and/or by one or more electronic devices, such as the controller 101 of FIG. 1A.

Although the example method 500 is illustrated and described as including particular operations performed in a particular order, it is understood that this is an example. In various implementations, various orders of the same, similar, and/or different operations may be performed without departing from the scope of the present disclosure.

For example, in some implementations, the electronic device may omit determining whether or not the combination is complete. In such implementations, the electronic device may move appropriate documents into the container, which may then be complete after all appropriate documents have been moved without any specific determination of such by the electronic device. Various configurations are possible and contemplated without departing from the scope of the present disclosure.

Returning to FIG. 2, the casino system 200 is illustrated and described above in the context of processing the output of at least one count sort machine. However, it is understood that this is an example. As is also illustrated and described above, the casino system 200 may be used for other operations beyond processing the output of at least one count sort machine without departing from the scope of the present disclosure. Examples of such operations may include, but are not limited to facilitating reconciliation between reported transactions and physical tickets stored in a cash box to account for variances that may result from virtual ticket and/or other operations, processing information related to contents of cash boxes in a casino environment, configuring cash boxes for use with gaming machines, and so on. Various configurations are possible and contemplated without departing from the scope of the present disclosure.

By way of illustration, as discussed above, the additional services server 107A may instruct one or more of the gaming machine 224, the peripheral adapter 225, and/or the bill validator 226 that a ticket is received based on a ticket and/or other account (such as from an electronic account that stores information about virtual tickets, an electronic account that is associated with a payment account that may be converted to virtual tickets, and so on). This virtual ticket may result in the gaming machine 224, the peripheral adapter 225, and/or the bill validator 226 behaving as if a physical ticket has been received, though the corresponding physical ticket may not be stored in the cash box 227. The additional services server 107A may also communicate with the gaming machine 224, the peripheral adapter 225, and/or the bill validator 226 in order to credit such accounts using such virtual tickets rather than a printer or other value output device associated with the gaming machine 224 printing physical tickets and/or providing other value outputs. The additional services server 107A may provide information (such as to the count sort machine 102, the count sort output system 100, and so on) regarding virtual ticket operations to enable, facilitate, and/or otherwise reconcile transaction records with contents of the cash box 227. For example, the gaming machine 224, the peripheral adapter 225, and/or the bill validator 226 may report all transactions to a slot accounting server, other accounting server, and/or other casino management server 221. Virtual ticket operations may result in the gaming machine 224, the peripheral adapter 225, and/or the bill validator 226 reporting transactions to the slot accounting server, other accounting server, and/or other casino management server 221 that correspond to received tickets. However, since the tickets are virtual, they may not be in the cash box 227 as the count sort machine 102 expects based on information received from the slot accounting server, other accounting server, and/or other casino management server 221. As such, the count sort machine 102 and/or other components may use the information regarding virtual ticket operations received from the additional services server 107A to reconcile discrepancies between transactions reported by the gaming machine 224, the peripheral adapter 225, and/or the bill validator 226 with physical tickets present in the cash box 227. Various configurations are possible and contemplated without departing from the scope of the present disclosure.

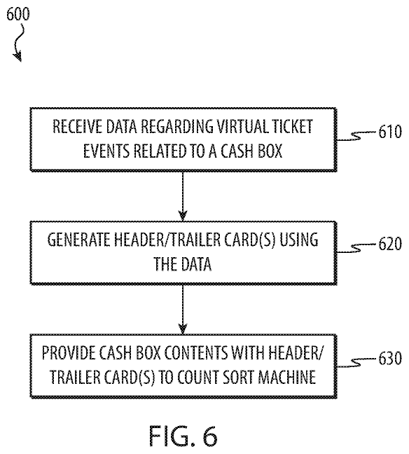

For example, FIG. 6 depicts a flow chart illustrating a first example method 600 for facilitating reconciliation between reported transactions and physical tickets stored in a cash box to account for variances that may result from virtual ticket and/or other operations. This method 600 may be performed by the casino system 200 of FIG. 2 and/or one or more of the other systems discussed and/or referenced herein.

At operation 610, an electronic device (such as one or more components of the drop processing system 107B of FIG. 2) may receive data regarding virtual tickets related to a cash box. For example, the data may indicate a number of virtual tickets that a bill validator associated with the cash box was instructed to behave as if it received even though a physical ticket was not received and stored in the cash box.

At operation 620, the electronic device may generate one or more header and/or trailer cards using the data. Such header and/or trailer cards may indicate to a count sort machine information about the contents of a cash box. This information may include a number of documents that were reported to be inside, serial numbers of documents reported to be inside, an aggregate value of the documents reported to be inside, an identifier for the cash box, an identifier for a bill validator and/or electronic gaming machine associated with the cash box, and so on. The generated header and/or trailer cards may indicate a number of virtual ticket transactions associated with the cash box so that a count sort machine may reconcile a reported number of tickets associated with the cash box with a lesser number of physical tickets in the contents of the cash box.

At operation 630, the electronic device may provide the cash box contents with the header/trailer card or cards to a count sort machine. For example, the electronic device may open the cash box, remove a stack of documents from the cash box, generate one or more header and/or trailer cards, add the one or more header and/or trailer cards to the stack of documents, and provide the stack of documents to the count sort machine.

In various examples, this example method 600 may be implemented as a group of interrelated software modules or components that perform various functions discussed herein. These software modules or components may be executed within a cloud network and/or by one or more electronic devices, such as one or more components of the drop processing system 107B of FIG. 2.

Although the example method 600 is illustrated and described as including particular operations performed in a particular order, it is understood that this is an example. In various implementations, various orders of the same, similar, and/or different operations may be performed without departing from the scope of the present disclosure.

For example, operation 620 is illustrated and described as generating one or more header and/or trailer cards. However, it is understood that this is an example. In some implementations, one or more header and/or trailer cards may be present in the stack of documents but may not reflect the virtual ticket transactions. As such, the one or more header and/or trailer cards may be removed from the stack of documents, read, and a modified set of one more header or trailer cards that update the previous set with the virtual ticket data may be generated before insertion into the stack of documents in replacement of the previous set. Various configurations are possible and contemplated without departing from the scope of the present disclosure.

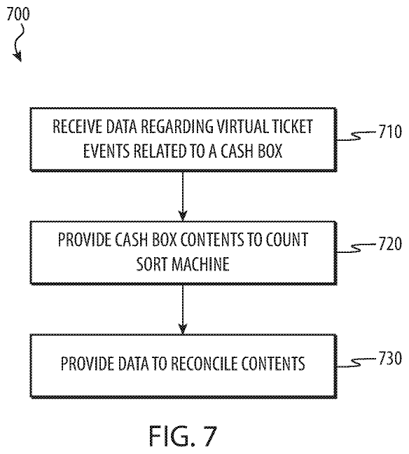

By way of another example, FIG. 7 depicts a flow chart illustrating a second example method 700 for facilitating reconciliation between reported transactions and physical tickets stored in a cash box to account for variances that may result from virtual ticket and/or other operations. This method 700 may be performed by the casino system 200 of FIG. 2 and/or one or more of the other systems discussed and/or referenced herein.

At operation 710, an electronic device (such as the additional services server 107A of FIG. 2) may receive data regarding virtual tickets related to a cash box. The electronic device may receive such data as part of instructing virtual ticket operations related to the cash box, may receive the data from a device that instructs such virtual ticket operations, and so on. At operation 720, the electronic device may provide the cash box contents to a count sort machine.

At operation 730, the electronic device may provide data to reconcile the contents. In some examples the electronic device may provide data to the count sort machine to reconcile the contents. This may prevent counting room personnel from having to manually compare a variance report against shortages that may be discovered in a counting room. In other examples, the electronic device may provide data to a slot accounting server, other accounting server, and/or other casino management server to reconcile the contents. This may also prevent counting room personnel from having to manually compare a variance report against shortages that may be discovered in a counting room. In still other examples, the electronic device may provide data to one or more other electronic devices to reconcile the contents, which may also prevent counting room personnel from having to manually compare a variance report against shortages that may be discovered in a counting room. Various configurations are possible and contemplated without departing from the scope of the present disclosure.

For example, the electronic device may notify the count sort machine of the number of virtual tickets that a bill validator associated with the cash box had been instructed regarding. The count sort machine may use this data to reconcile a reported number of tickets received with the number of physical tickets present in the cash box. As such, operators of the count sort machine may be able to reconcile reported counts with count results provided by the count sort machine in real time rather than waiting for all counts to be complete in order to find and explain any variances.

By way of another example, the electronic device may notify a slot accounting server, other accounting server, and/or other casino management server of the number of virtual tickets that a bill validator associated with the cash box had been instructed regarding. The slot accounting server, other accounting server, and/or other casino management server may have also received information from one or more bill validators and/or other components regarding transactions that correspond to received physical and/or virtual tickets. The slot accounting server, other accounting server, and/or other casino management server may use the data provided by the electronic device to reconcile a reported number of tickets received with the number of physical tickets present that are actually present in the cash box. The slot accounting server, other accounting server, and/or other casino management server may thus adjust the reported count for virtual tickets not physically present before providing the reported count to the count sort machine and/or operators of such for comparison to count sort machine results. Thus, comparison of the reported count to the count sort machine results may not result in variances for virtual tickets as the reported count used for such comparison may have already been adjusted for such. This may result in fewer detected variances and not require time and/or resources to exp find and explain such variances.

In various examples, this example method 700 may be implemented as a group of interrelated software modules or components that perform various functions discussed herein. These software modules or components may be executed within a cloud network and/or by one or more electronic devices, such as such the additional services server 107A of FIG. 2.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 is illustrated and described as the electronic device providing the cash box contents to the count sort machine at operation 720. However, it is understood that this is an example. In various implementations, the electronic device may receive and provide the data without providing the cash box contents to the count sort machine. In such implementations, another device or system may provide the cash box contents to the count sort machine. As such, operation 720 may be omitted. Various configurations are possible and contemplated without departing from the scope of the present disclosure.

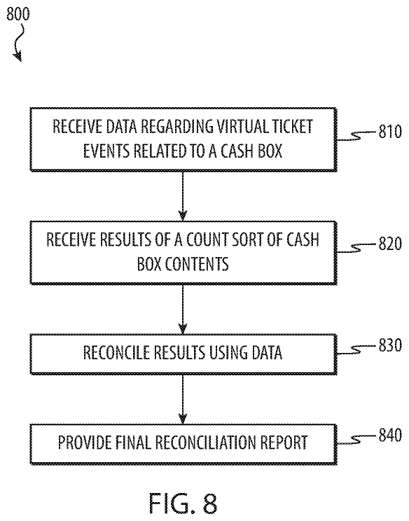

In still another example, FIG. 8 depicts a flow chart illustrating a third example method 800 for facilitating reconciliation between reported transactions and physical tickets stored in a cash box to account for variances that may result from virtual ticket and/or other operations. This method 800 may be performed by the casino system 200 of FIG. 2 and/or one or more of the other systems discussed and/or referenced herein.

At operation 810, an electronic device (such as the additional services server 107A and/or the count sort machine 102 of FIG. 2) may receive data regarding virtual tickets related to a cash box. At operation 820, the electronic device may receive results of a count sort of the cash box contents. For example, the results may indicate a number of documents, a number of documents of each type (such as a number of tickets, a number of each denomination of currency, and so on), an aggregate value of the documents, serial numbers of documents in the cash box, an aggregate value of each type of document, variances between any documents from the cash box and those reported to be in the cash box, and so on.

At operation 830, the electronic device may reconcile the result with the data. For example, the electronic device may reconcile a variance between an expected number of tickets and an actual number of tickets from the result using data that indicates that the variance corresponds to virtual tickets and thus does not actually indicate a variance.

At operation 840, the electronic device may provide a final reconciliation report. The final reconciliation report may reconcile expected contents to actual contents, indicate any variances that were not able to be explained using the data, indicate variances explained using the data, and so on.

In various examples, this example method 800 may be implemented as a group of interrelated software modules or components that perform various functions discussed herein. These software modules or components may be executed within a cloud network and/or by one or more electronic devices, such as the additional services server 107A and/or the count sort machine 102 of FIG. 2.

Although the example method 800 is illustrated and described as including particular operations performed in a particular order, it is understood that this is an example. In various implementations, various orders of the same, similar, and/or different operations may be performed without departing from the scope of the present disclosure.

For example, operation 820 is illustrated and described as receiving the results of a count sort. However, it is understood that this is an example. In some implementations, the method 800 may be performed using a count sort machine. As such, operation 820 may be replaced by performing a count sort of the cash box documents. Various configurations are possible and contemplated without departing from the scope of the present disclosure.

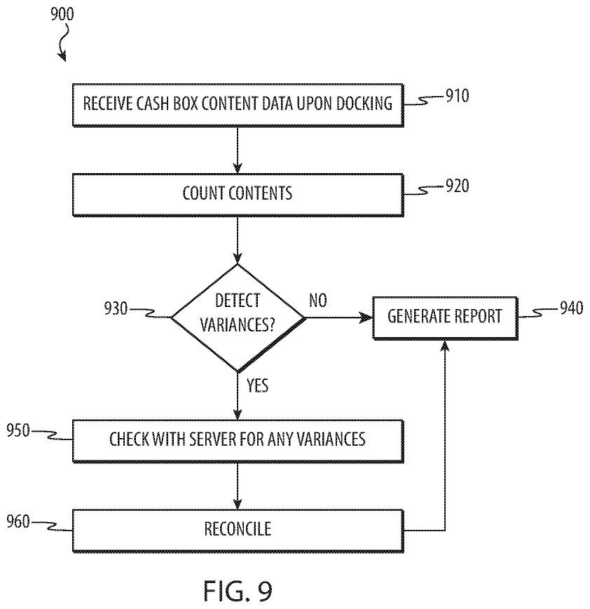

In yet another example, FIG. 9 depicts a flow chart illustrating a fourth example method 900 for facilitating reconciliation between reported transactions and physical tickets stored in a cash box to account for variances that may result from virtual ticket and/or other operations. This method 900 may be performed by the casino system 200 of FIG. 2 and/or one or more of the other systems discussed and/or referenced herein.

At operation 910, an electronic device (such as the count sort machine 102 of FIG. 2) may receive cash box contents upon docketing. For example, the electronic device may receive the cash box contents upon docking of the cash box contents to the electronic device, to a count sort machine, to a drop cart and/or other component of a drop processing system such as the drop processing system 107B of FIG. 2, and so on.

At operation 920, the electronic device may count the contents. The flow may then proceed to operation 930 where the electronic device may determine whether or not any variances are detected between the counted cash box contents and a reported contents of the cash box. If not, the flow may proceed to operation 940 where the electronic device may generate a report of the results of the count. Otherwise, the flow may proceed to operation 950.

At operation 950, the electronic device may check with a server (such as the additional services server 107A of FIG. 2) for any variances. For example, the electronic device may check with a server to see if there are any variances related to virtual ticket transactions that may have resulted in a number of expected tickets being greater than a number of physical tickets counted in the contents of the cash box.

At operation 960, the electronic device may reconcile the counted contents with any variances reported by the server. The flow may then proceed to operation 940 where the electronic device may generate a report of the results of the count.

In various examples, this example method 900 may be implemented as a group of interrelated software modules or components that perform various functions discussed herein. These software modules or components may be executed within a cloud network and/or by one or more electronic devices, such as the count sort machine 102 of FIG. 2.

Although the example method 900 is illustrated and described as including particular operations performed in a particular order, it is understood that this is an example. In various implementations, various orders of the same, similar, and/or different operations may be performed without departing from the scope of the present disclosure.

For example, operation 920 is illustrated and described as counting the contents of the cash box. However, it is understood that this is an example. In various implementations, other operations may be included in the method 900. For example, the contents of the cash box may be sorted in addition to being counted. Various configurations are possible and contemplated without departing from the scope of the present disclosure.

FIGS. 6-9 are all illustrated and described as methods 600-900 for facilitating reconciliation between reported transactions and physical tickets stored in a cash box to account for variances that may result from virtual ticket and/or other operations. However, it is understood that these are examples. As is illustrated and described above, the casino system 200 may be used for other operations beyond facilitating reconciliation between reported transactions and physical tickets stored in a cash box to account for variances that may result from virtual ticket and/or other operations.

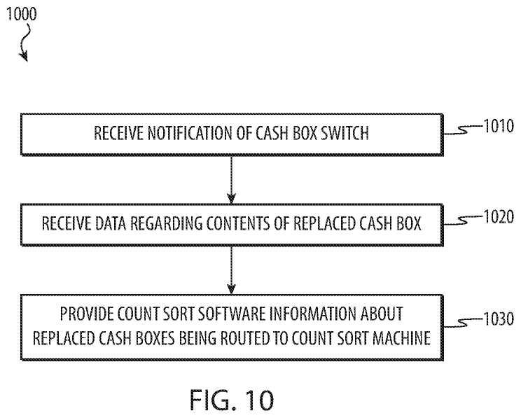

For example, FIG. 10 depicts a flow chart illustrating a first example method 1000 for processing information related to contents of cash boxes in a casino environment. This method 1000 may be performed by the casino system 200 of FIG. 2 and/or one or more of the other systems discussed and/or referenced herein.

At operation 1010, an electronic device (such as the additional services server 107A of FIG. 2) may receive a notification of a cash box switch. For example, a cash box associated with a bill validator and/or an electronic gaming machine may be removed, routed to a counting room for emptying and processing of its contents, and replaced with another cash box. The electronic device may receive a notification that removal of the cash box and/or replacement of the cash box by another cash box has been detected.

At operation 1020, the electronic device may receive data regarding contents of the replaced cash box. For example, the data may be received from a server such as the additional services server 107A of FIG. 2 that monitors transactions related to the cash box. By way of another example, the data may be received from a drop cart and/or other component of a drop processing system, such as the drop processing system 107B of FIG. 2. By way of yet another example, the data may be received from a storage medium of the cash box that may be configured to store and/or communicate data regarding transactions related to the cash box and/or documents received and/or stored therein.

At operation 1030, the electronic device may provide count sort software information about replaced cash boxes being routed to a count sort machine. This information may include part or all of the data received in operation 1020. Such information may enable the count sort software to prepare for a count sort operation, anticipate what will be performed as part of reconciliation, organize performance of a count sort operation, allocate resources and/or personnel for performing a count sort operation, route replacement cash boxes, schedule cash box traffic in a counting room, and so on.

In various examples, this example method 1000 may be implemented as a group of interrelated software modules or components that perform various functions discussed herein. These software modules or components may be executed within a cloud network and/or by one or more electronic devices, such as the additional services server 107A of FIG. 2.

Although the example method 1000 is illustrated and described as including particular operations performed in a particular order, it is understood that this is an example. In various implementations, various orders of the same, similar, and/or different operations may be performed without departing from the scope of the present disclosure.

For example, operation 1020 is illustrated and described as receiving data regarding the contents of the replaced cash box. However, it is understood that this is an example. In some implementations, the electronic device may already store the data regarding the contents of the replaced cash box. In such an implementation, operation 1020 may be omitted. Various configurations are possible and contemplated without departing from the scope of the present disclosure.

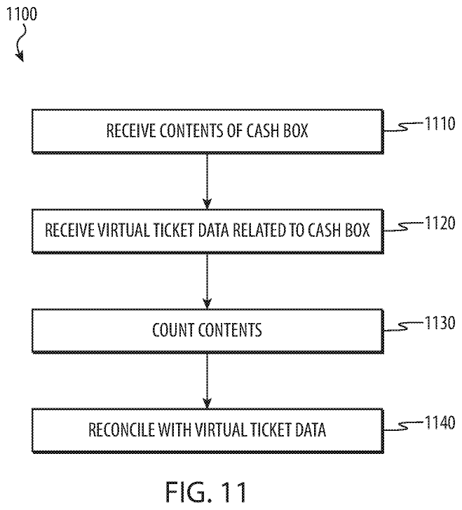

By way of another example, FIG. 11 depicts a flow chart illustrating an example method 1100 for reconciliation of reported transactions and physical tickets stored in a cash box to account for variances that may result from virtual ticket and/or other operations. This method 1100 may be performed by the casino system 200 of FIG. 2 and/or one or more of the other systems discussed and/or referenced herein.

At operation 1110, an electronic device (such as the count sort machine 102 of FIG. 2) may receive the contents of a cash box. At operation 1120, the electronic device may receive virtual ticket data related to the cash box. At operation 1130, the electronic device may count the contents of the cash box. At operation 1140, the electronic device may reconcile the count with the virtual ticket data.

For example, the electronic device may receive data indicating a number of virtual tickets that had been instructed related to transactions associated with the cash box, indicating a number of tickets reported as being received and/or stored in the cash box that will not correspond to physical tickets counted from the cash box. The reported number of tickets may be reconciled with the physical tickets counted by subtracting the number of virtual tickets. Various configurations are possible and contemplated without departing from the scope of the present disclosure.

In various examples, this example method 1100 may be implemented as a group of interrelated software modules or components that perform various functions discussed herein. These software modules or components may be executed within a cloud network and/or by one or more electronic devices, such as one or more components of the count sort machine 102 of FIG. 2.

Although the example method 1100 is illustrated and described as including particular operations performed in a particular order, it is understood that this is an example. In various implementations, various orders of the same, similar, and/or different operations may be performed without departing from the scope of the present disclosure.

For example, operation 1130 is illustrated and described as counting the contents of the cash box. However, it is understood that this is an example. In some implementations, the electronic device may receive a result of a count of the contents of the cash box instead of counting the contents of the cash box itself. Various configurations are possible and contemplated without departing from the scope of the present disclosure.

In still another example, both a storage medium associated with the cash box 227 and the additional services server 107A of FIG. 2 may monitor and store information regarding the contents of the cash box 227. However, the additional services server 107A and/or the peripheral adapter 225 (and/or the network 223 and/or other components) may be unavailable at various times. This could result in a discrepancy between the information stored in the storage medium associated with the cash box 227 and the additional services server 107A regarding the contents of the cash box 227. In some implementations, the cash box 227 may be disabled when the additional services server 107A and/or the peripheral adapter 225 are unavailable (such as by disabling itself when unable to communicate with the additional services server 107A and/or the peripheral adapter 225, by receiving a disabling instruction when the additional services server 107A and/or the peripheral adapter 225 are unavailable, and so on).

In other implementations, the cash box 227 may continue to operate when the additional services server 107A and/or the peripheral adapter 225 are unavailable. In such implementations, the information stored in the storage medium associated with the cash box 227 may be more accurate than the information stored by the additional services server 107A due to transactions that the information stored in the storage medium associated with the cash box 227 recorded data regarding while the additional services server 107A did not due to unavailability of the additional services server 107A and/or the peripheral adapter 225. As such, the information stored in the storage medium associated with the cash box 227 may be used to correct the information stored by the additional services server 107A.

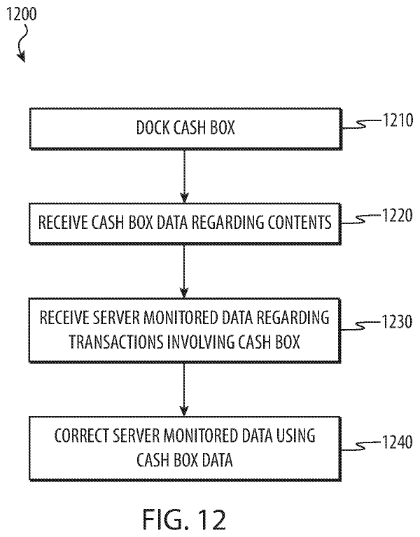

By way of illustration, FIG. 12 depicts a flow chart illustrating a second example method 1200 for processing information related to contents of cash boxes in a casino environment. This method 1200 may be performed by the casino system 200 of FIG. 2 and/or one or more of the other systems discussed and/or referenced herein.

At operation 1210, an electronic device (such as the additional services server 107A of FIG. 2) may dock a cash box for counting and/or transportation to a counting room. This may include detecting that the cash box has been docked, directing components that perform the docking, and so on. At operation 1220, the electronic device may receive cash box data regarding the contents of the cash box. At operation 1230, the electronic device may receive server monitored data regarding transactions involving the cash box. At operation 1240, the electronic device may correct the server monitored data using the cash box data.

For example, the server monitored data may be missing information that is present in the cash box data related to transactions performed while the server was unavailable. As such, the server monitored data may be corrected by adding the missing information from the cash box data to the server monitored data. Various configurations are possible and contemplated without departing from the scope of the present disclosure.

In various examples, this example method 1200 may be implemented as a group of interrelated software modules or components that perform various functions discussed herein. These software modules or components may be executed within a cloud network and/or by one or more electronic devices, such as the additional services server 107A of FIG. 2.

Although the example method 1200 is illustrated and described as including particular operations performed in a particular order, it is understood that this is an example. In various implementations, various orders of the same, similar, and/or different operations may be performed without departing from the scope of the present disclosure.

For example, operation 1210 is illustrated and described as the electronic device docking the cash box. However, it is understood that this is an example. In some implementations, operation 1220 may be omitted. Various configurations are possible and contemplated without departing from the scope of the present disclosure.

By way of another example, the method 1200 is illustrated and described as correcting the server monitored data using the cash box data. However, it is understood that this is an example. In other implementations, the cash box data may instead be corrected using the server monitored data. Various configurations are possible and contemplated without departing from the scope of the present disclosure.

By way of yet another example of functions that may be performed using the casino system 200 of FIG. 2, cash boxes may be associated and/or de-associated with particular gaming machines 224, bill validators 226, and/or game cabinets 222 and/or other components. In many systems, cash boxes may be manually paired with gaming machines, bill validators, and/or other components. Before that paired cash box may be used with another machine, the cash box may need to be manually de-paired and/or repaired.

However, in various implementations, asset identifiers and/or other identifiers may be associated with the cash box 227 (which may be stored in a storage medium of the cash box 227, by the additional services server 107A, and so on) and the gaming machine 223, game cabinet 222, peripheral adapter 225, bill validator 226, and so on. These asset identifiers may be assigned and stored and/or correlated when the cash box 227 is coupled to and/or otherwise associated with the bill validator 226 and/or other component. This asset identifier may be wiped (such as by wiping the asset identifier from the storage medium of the cash box 227 and/or by the additional services server 107A) and/or otherwise de-associated with the cash box 227 when the cash box 227 is processed (such as by docking to a drop cart and/or other component of the drop processing system 107B, delivery of the contents of the cash box 227 to the count sort machine 102, and so on). The cash box 207 may then be used with another gaming machine 223, game cabinet 222, peripheral adapter 225, bill validator 226, and so on whereupon another asset identifier may be assigned (which may be stored in a storage medium of the cash box 227, by the additional services server 107A, and so on). Various configurations are possible and contemplated without departing from the scope of the present disclosure.

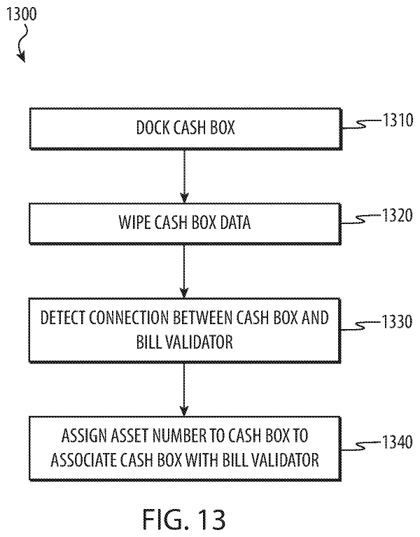

By way of illustration, FIG. 13 depicts a flow chart illustrating an example method 1300 for configuring cash boxes for use with gaming machines. This method 1300 may be performed by the casino system 200 of FIG. 2 and/or one or more of the other systems discussed and/or referenced herein.

At operation 1310, an electronic device (such as one or more components of the drop processing system 107B, the bill validator 226, the additional services server 107A, and/or the count sort machine 102 of FIG. 2) may dock a cash box. Docking may involve obtaining cash box data from the cash box. At operation 1320, the electronic device may wipe the cash box data. At operation 1330, the electronic device may detect a connection between a cash box and a bill validator. At operation 1340, the electronic device may assign an asset identifier and/or other identifier or asset number to the cash box to associate what cash box with the bill validator and/or a related gaming machine or component.

For example, a system may dock a cash box with a drop cart of a drop processing system, such as the drop processing system 107B of FIG. 2. The system may read the cash box data, remove the contents of the cash box, wipe the cash box data from the cash box, and deliver the cash box for use in another gaming machine. Upon connection of the cash box to a bill validator associated with the new gaming machine, new asset identifier may be associated with the cash box, stored in the cash box data of the cash box, and/or updated in a record stored by the additional services server 107A. Various configurations are possible and contemplated without departing from the scope of the present disclosure.

In various examples, this example method 1300 may be implemented as a group of interrelated software modules or components that perform various functions discussed herein. These software modules or components may be executed within a cloud network and/or by one or more electronic devices, such as one or more components of the drop processing system 107B, the bill validator 226, the additional services server 107A, and/or the count sort machine 102 of FIG. 2.

Although the example method 1300 is illustrated and described as including particular operations performed in a particular order, it is understood that this is an example. In various implementations, various orders of the same, similar, and/or different operations may be performed without departing from the scope of the present disclosure.

For example, the method 1300 is illustrated as including the operations 1310 and 1320. However, it is understood that this is an example. In some implementations, another electronic device may perform the operations 1310, 1320, and/or similar operation and the method 1300 may omit the operations 1310 and/or 1320. Various configurations are possible and contemplated without departing from the scope of the present disclosure.

In various implementations, a system for processing output of at least one count sort machine may include at least one movement mechanism, at least one data source, and at least one controller. The at least one controller may receive data from the at least one data source regarding cash box documents provided to the at least one count sort machine, determine a combination of the cash box documents for an output container using the data, and operate the at least one movement mechanism to move at least a portion of the cash box documents from the at least one count sort machine to the output container based on the combination.

In some examples, the at least one movement mechanism may include a conveyor. In various examples, the at least one movement mechanism may include a linear robot. In some examples, the at least one controller may move the portion of the cash box documents after the portion of the cash box documents is banded.

In a number of examples, the combination may include a first number of a first currency denomination and a second number of a second currency denomination. In some examples, the combination may be associated with an aggregate currency value.

In various examples, the at least one controller may communicate the combination to at least one machine readable storage medium associated with the output container.

In some embodiments, a system for processing output of at least one count sort machine may include at least one movement mechanism, at least one sensor, and at least one controller. The at least one controller may use data regarding cash box documents provided to the at least one count sort machine to determine a combination of the cash box documents for an output container using the data, use the at least one sensor to identify at least a portion of the cash box documents output by the at least one count sort machine, and operate the at least one movement mechanism to move the portion of the cash box documents from the at least one count sort machine to the output container in fulfillment of the combination.

In various examples, the at least one sensor may be a camera. In some such examples, the at least one controller may identify the portion of the cash box documents using optical character recognition performed on at least one image of the portion of the cash box documents obtained via the camera.

In some examples, the at least one controller may identify the portion of the cash box documents by identifying at least one currency denomination associated with the portion of the cash box documents. In various examples, the at least one controller may identify the portion of the cash box documents by identifying at least one serial number associated with the portion of the cash box documents.

In a number of examples, the at least one controller may identify the portion of the cash box documents by identifying at least one security feature associated with the portion of the cash box documents. In some such examples, the at least one security feature may include at least one of an infrared strip or an ultraviolet strip.

In a number of embodiments, a system for processing output of at least one count sort machine may include at least one movement mechanism, at least one sensor, and at least one controller. The at least one controller may use the at least one sensor to identify at least a portion of cash box documents output by the at least one count sort machine and operate the at least one movement mechanism to move the portion of the cash box documents from the at least one count sort machine to an output container based on a combination determined using data regarding the cash box documents provided to the at least one count sort machine.

In various examples, the at least one controller may use at least one locking mechanism to lock the output container after the output container contains the combination. In some examples, the at least one controller may identify the portion of the cash box documents by determining which of a number of output ports of the at least one count sort machine output the portion of the cash box documents.

In a number of examples, the at least one controller may identify the portion of the cash box documents by using the at least one sensor to obtain identification data from at least one machine readable element associated with at least one band wrapping at least a part of the portion of the cash box documents. In some such examples, the at least one machine readable element includes at least one barcode.

In various examples, the combination may be associated with an aggregate currency denomination number.

Although the above describes a number of different embodiments, it is understood that various techniques from these embodiments may be combined in other embodiments without departing from the scope of the present disclosure. Various implementations are possible and contemplated.

As described above and illustrated in the accompanying figures, the present disclosure relates to processing the output of at least one count sort machine. Data regarding cash box documents provided to at least one count sort machine is evaluated in determining one or more combinations of the cash box documents for one or more output containers. One or more movement mechanisms are operated to move at least a portion of the cash box documents from one or more output ports of the at least one count sort machines to the one or more output containers based on the combination.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A system for processing output of at least one count sort machine, comprising:
at least one movement mechanism;
at least one data source; and
at least one controller that:
receives data from the at least one data source regarding cash box documents provided to the at least one count sort machine;
determines a combination of the cash box documents for an output container using the data wherein the combination is based on one or more of the following:
an aggregate value of documents;
an aggregate number of documents;
an aggregate number of a currency denominations; and
deposit requirements; and
operates the at least one movement mechanism to move at least a portion of the cash box documents from the at least one count sort machine to the output container in fulfillment of the combination.

2. The system of claim 1, wherein the at least one movement mechanism includes a conveyor.

3. The system of claim 1, wherein the at least one movement mechanism includes a linear robot.

4. The system of claim 1, wherein the at least one controller moves the portion of the cash box documents after the portion of the cash box documents is banded.

5. The system of claim 1, wherein the combination includes:
a first number of a first currency denomination; and
a second number of a second currency denomination.

6. The system of claim 1, wherein the combination is associated with an aggregate currency value.

7. The system of claim 1, wherein the at least one controller communicates the combination to at least one machine readable storage medium associated with the output container.

8. A system for processing output of at least one count sort machine, comprising:
at least one movement mechanism;
at least one sensor; and
at least one controller that:
uses data regarding cash box documents provided to the at least one count sort machine to determine a combination of the cash box documents for an output container using the data wherein the combination is based on one or more of the following:
an aggregate value of documents;
an aggregate number of documents;
an aggregate number of a currency denominations; and
deposit requirements;
uses the at least one sensor to identify at least a portion of the cash box documents output by the at least one count sort machine; and
operates the at least one movement mechanism to move the portion of the cash box documents from the at least one count sort machine to the output container in fulfillment of the combination.

9. The system of claim 8, wherein the at least one sensor comprises a camera.

10. The system of claim 9, wherein the at least one controller identifies the portion of the cash box documents using optical character recognition performed on at least one image of the portion of the cash box documents obtained via the camera.

11. The system of claim 8, wherein the at least one controller identifies the portion of the cash box documents by identifying at least one currency denomination associated with the portion of the cash box documents.

12. The system of claim 8, wherein the at least one controller identifies the portion of the cash box documents by identifying at least one serial number associated with the portion of the cash box documents.

13. The system of claim 8, wherein the at least one controller identifies the portion of the cash box documents by identifying at least one security feature associated with the portion of the cash box documents.

14. The system of claim 13, wherein the at least one security feature includes at least one of:
an infrared strip; or
an ultraviolet strip.

15. A system for processing output of at least one count sort machine, comprising:
at least one movement mechanism;
at least one sensor; and
at least one controller that:
uses the at least one sensor to identify at least a portion of cash box documents output by the at least one count sort machine;
operates the at least one movement mechanism to move the portion of the cash box documents from the at least one count sort machine to an output container in fulfillment of a combination determined using data regarding the cash box documents provided to the at least one count sort machine wherein the combination is based on one or more of the following:
an aggregate value of documents;
an aggregate number of documents;
an aggregate number of a currency denominations; and
deposit requirements.

16. The system of claim 15, wherein the at least one controller uses at least one locking mechanism to lock the output container after the output container contains the combination.

17. The system of claim 15, wherein the at least one controller identifies the portion of the cash box documents by determining which of a number of output ports of the at least one count sort machine output the portion of the cash box documents.

18. The system of claim 15, wherein the at least one controller identifies the portion of the cash box documents by using the at least one sensor to obtain identification data from at least one machine readable element associated with at least one band wrapping at least a part of the portion of the cash box documents.

19. The system of claim 18, wherein the at least one machine readable element comprises at least one barcode.

20. The system of claim 15, wherein the combination is associated with an aggregate currency denomination number.
